(19) United States
(12) Patent Application Publication
(10) Pub. No.: US 2021/0140548 A1
(43) Pub. Date: May 13, 2021

(54) MACHINE TOOL

(71) Applicant: Ivoclar Vivadent AG, Schaan (LI)

(72) Inventors: Alfons Wörmer, Bischofshofen (AT); Martin Huber, Pfarrwerfen (AT)

(21) Appl. No.: 17/093,857

(22) Filed: Nov. 10, 2020

(30) Foreign Application Priority Data
Nov. 11, 2019 (EP) 19208412.7

(51) Int. Cl. F16J 15/40; B23B 31/16

(52) U.S. Cl. CPC F16J 15/40; B23B 31/16

(57) ABSTRACT

The invention relates to a machine tool, in particular a lathe grinding machine, comprising a tool spindle having a collet and a spindle motor, wherein the collet has at least two clamping jaws which are actuatable for receiving and releasing a tool, and comprising an air channel which runs radially on the outside of the collet, wherein the air channel is configured as a sealing air channel (42) and forms a positive pressure chamber (44) at least partially above the clamping jaws (26).

### CROSS-REFERENCE TO RELATED APPLICATIONS

This application claims priority to European patent application No. 19208412.7 filed on Nov. 11, 2019, the disclosure of which is incorporated herein by reference in its entirety.

### TECHNICAL FIELD

The invention relates to a machine tool, in particular a machine tool having a spindle motor and a tool spindle extending to the top therefrom, and particularly preferably to a lathe grinding machine.

### BACKGROUND

Machine tools which include lathe grinding machines have become known in numerous forms. Type 5/0 machines are particularly suitable for certain applications in which zero movement axes of the tool are combined with 5 movement axes of the workpiece.

The movement axes of the workpiece are typically provided by a robot arm and are 3 translational and 2 rotational movement axes. In contrast, the rotating tool remains stationary at a tool spindle which is driven by a spindle motor and realized fixed in space.

When the workpiece is machined by the tool, chips are produced which vary depending on the material combination of workpiece and tool used.

For instance, when machining PMMA, plastic chips are produced.

If, for instance, ceramic dental restorations are lathe ground or milled, both grainy or granular and almost dust-like deposits are produced.

While the granular deposits sink down due to their own weight, the dust-like deposits are initially present in the form of a mist, which sinks very slowly but which forms a layer of dust at the bottom of the lathe grinding machine when the spindle motor is not running after completion of the machining process.

To reduce contamination of the milling space it has become known to clean the milling space by means of air nozzles which are attached particularly preferably to the upper edge of the work space.

A suction opening which is to ensure removal of the deposits is typically arranged diametrically opposed to the air nozzles.

A solution of this type has become known for instance from EP 3 012 065 A1 and corresponding U.S. Ser. No. 10/562,144, which is hereby incorporated by reference in its entirety. US 20130244846, 20140018219, 20120220437, 20040176228, 20040146368, 20020045521, U.S. Pat. Nos. 10,792,735, 9,162,335, 3,542,372, 5,002,442, 9,849,551, 9,044,251, 8,827,608, 6,663,548, 6,059,702, 5,927,913, 5,762,454, and 5,570,980 are also directed to machine tools and are hereby incorporated by reference in their entirety.

In addition, it has become known that the machining area, i.e., the region in which the tool machines the workpiece, needs to be particularly cleaned. For this purpose, it has become known according to EP 3 338 945 A1 to arrange nozzles at the tool spindle through which both water and compressed air may be supplied selectively to the machining area in order to keep this important region free from deposits if possible.

Typically, lathe grinding machines have comparatively low required torque, but high speed of rotation of the spindle motor for the respective desired machining progress. It typically amounts to 40,000 rpm (revolutions per minute) but may also amount to up to 80,000 rpm.

In such a case of a high speed of rotation it is essential to realize very precise mounting of the bearing arrangement. Ball bearings with a bearing clearance of approximately 500 nm are used, which can absorb the required support forces even at such high speeds.

Typically, 2 to 4 ball bearings are provided on top of one another to support the spindle.

However, one dust particle alone would already have an abrading effect at a speed this high if it entered the ball bearing track.

Thus, the air in the area of the bearings, streams through the region of the bearings in an air channel. The bearings air is cleaned by filters which are connected in series, i.e., initially a coarse filter, then a fine filter, and basically forms a cylinder gap around the tool spindle.

This gap ends slightly above the uppermost ball bearing. When the rotary or lathe grinding machine is turned off, particle dust deposits may settle there.

During operation, the air in the bearings area escapes as sealing air at the collets and is intended to prevent deposits.

Before the spindle motor is switched on, the bearing clearance and thus the sealing air is switched on so that any deposits there can be expelled.

Further, at high rotational speeds, it is important that the tool is held concentrically, i.e., free from deviations, in the typically used collet chuck. For this purpose, self-centering clamping jaws are preferred, which slide along inclined surfaces and clamp the tool by axial spring pressure. For tool change, a rear pressure plate ensures that the clamping jaws are moved forward so that they guided radially outward at the inclined surfaces and release the tool.

The compressed air for loosening or releasing the collet chuck is present at a pressure of between 6 and 8 bar, which is considerably more than the bearing air or clearance, which requires a pressure of e.g., 2 bar.

In order to keep the area of the clamping jaws and thus the collet chuck free of deposits, it has been suggested to supply a short air impulse through the collet chuck to clean the deposits thereat when the tool is changed so that the next tool may be centered automatically again.

Particularly if machine tools are standing idle for a longer period of time, the deposits may stick thereto such that they cannot be loosened at all or completely loosened by the compressed air impulse.

This leads to eccentricity and to extensive strain on the spindle bearing, to increased tool wear or possibly less accurate production of the workpiece.

A corresponding workpiece can, e.g., be a ceramic dental restoration part in which particularly good accuracy is important.

### SUMMARY

In contrast, the invention is based on the task of providing a machine tool, which is particularly suitable for the production of dental restoration parts and which also achieves good results when it comes to accuracy in the long run.

This task is inventively solved by the claims. Advantageous developments may be taken from the subclaims.

According to the invention, it is provided to make sealing air flow such that it also prevents deposits from entering the collet or also known as a collet chuck.

For this purpose, an over pressure or excess pressure or positive pressure area or space or room or chamber is purposefully created without further ado above the collet chuck.

It is fed by sealing air and ends in an annular gap positioned above where the sealing air streams out and thus prevents deposits from entering the collet right from the start.

It is particularly advantageous that the sealing air for the collet may be combined with the sealing air for the roller bearings. For this purpose, the sealing air, as bearings air, preferably first passes through the air channel of the roller bearings. Subsequent thereto, it is then led further upwards so that the sealing air channel extends above the upper end of the collet chuck.

It is beneficial to have a configuration wherein an annular gap is created between a spindle joint and the tool or the spindle which has a comparatively high flow resistance and thus creates the positive pressure area or space.

This annular gap can be realized with an axially oriented outlet surface or area, with an outlet surface or area directed obliquely to or inclined toward the tool axis or which is directed radially or slightly inclined forward or to the front.

In an advantageous configuration of the invention it is provided that the air duct or channel is configured as a sealing air duct or channel and forms a positive pressure room, area, space or channel at least partially above the clamping jaws.

In an advantageous configuration of the invention it is provided that the positive pressure space or room terminates in an annular gap or that an annular gap is arranged downstream of the positive pressure room whose one gap side is formed by the tool or the collet.

In an advantageous configuration of the invention it is provided that an annular gap has a gap size of between 0.03 mm and 0.5 mm and in particular of between 0.08 and 0.15 mm downstream of the positive pressure chamber.

In one advantageous embodiment, provision is made that the downstream end of the over-pressure room which end is formed by both sides of the annular gap consists of a sturdy material like hard plastic or metal. This allows the gap dimension of the annular gap between the upper end of the spindle casing and the tool or the tool spindle to have a constant width, especially a constant gap between 0.05 mm and 1.5 mm and preferably between 0.15 and 0.8 mm, and particularly preferably between 0.3 and 0.5 mm, even under high rotational speeds like rotational speeds of more than 30,000 rpm such as 60,000 rpm.

It is advantageous if both the upper end of the spindle casing or housing and the tool or the spindle and the upper end of the spindle casing are made from metal. In another embodiment the spindle is made from metal and the housing is made from a plastic material, especially from a hard plastic. Some examples of hard plastic include, but are not limited to, acrylic, polymethyl methacrylate (pmma), polycarbonate (pc), high density polyethylene (pe), polypropylene (pp), polyethylene terephthalate (pete or pet), polyvinyl chloride (pvc), and acrylonitrile-butadiene-styrene (abs).

The gap width stays constant with a tolerance between 1 percent and 8 percent of the gap width, irrespective of the operating temperature of the inventive machine tool. By this, the gap acts as a reliable “nozzle” to blow away any chips and any contamination of the working area, and, as there is no contact between the upper end of the spindle casing and said spindle, there is no wearing.

In an advantageous configuration of the invention it is provided that an annular gap downstream of the positive pressure chamber has an orientation coaxial to the tool axis or an orientation which deviates from the axis of the tool spindle by +/−30° at most.

In an advantageous configuration of the invention it is provided that the tool has at least one annular web which protrudes radially to the outside, and in that the sealing air channel terminates at the annular web.

In an advantageous configuration of the invention it is provided that the sealing air channel is configured upstream of the positive pressure chamber as a bearings air channel.

In an advantageous configuration of the invention, it is provided that the collet chuck is provided with a compressed air source which acts on the clamping jaws from behind via a pressure plate to open the clamping jaws and in particular that the compressed air source feeds the sealing air channel via a pressure reduction valve.

Realization of a radial outlet area is advantageous particularly if the tool is provided with an annular web. Such an annular web is typically provided anyways in modem lathe grinding machines and serves to easily handle the tool at a gripping fork for tool change.

As it were, the annular flange covers the annular gap.

It is also possible that the tool comprises several annular flanges axially behind one another which are separated by annular grooves.

For instance, 3 annular flanges and 2 annular grooves may be provided, and the annular flanges may protrude to a varying degree axially.

In this case, it is favorable when the annular gap is configured at the annular flange with the largest diameter.

It is to be understood that the inventive effects show to particular advantage in case of a machine tool with a vertically upright tool spindle. Basically, realization of the additional sealing air for the tool spindle is favorable even if a horizontal tool spindle is used as due to the turbulence through the movement and the air flows in the milling space even then there is the risk that the collet is contaminated by deposits.

Here, a vertically upright tool spindle refers to an arrangement in which the tool is positioned at the top and inserted into the collet from top to bottom to be clamped thereat.

According to the invention, the housing of the tool spindle extends further to the top compared to prior art for creating the positive pressure room. Thus, it does not end just above the uppermost rolling bearing but few centimeters or approximately 1 centimeter above the position at which the annular land or flange of the tool is provided, thus forming an annular gap.

In this respect, the positive pressure room extends between the bearings air channel and the inventively arranged annular gap.

The housing of the tool spindle typically tapers conically to the top. It is favorable if the cone from prior art is continued to the top without further ado such that the housing of the tool spindle is additionally more slender at the top.

But still enough space remains to provide a nozzle plate for air nozzles which extend radially to the outside of the annular gap on a surface with a normal that is axially parallel. Preferably, the air nozzles known per se terminate further up.

This has the additional advantage that the outlet of the flow medium, i.e. air or water, has been moved closer to the machining area because of these cleaning nozzles such that a better and more targeted cleaning process is possible thereat.

It is preferable that the machine tool includes a tool spindle having a collet chuck and a spindle motor, an air channel which runs radially on the outside of the collet chuck, wherein the collet chuck has at least two clamping jaws which are actuatable for receiving and releasing a tool, and wherein the air channel is configured as a sealing air channel and forms a positive pressure chamber at least partially above the clamping jaws.

It is preferable that the positive pressure chamber terminates in an annular gap or that an annular gap is arranged downstream of the positive pressure chamber having one gap side formed by the tool or the tool spindle.

It is preferable that the annular gap which is covered and/or limited by an annular flange has a radial orientation or an orientation which deviates from the radial orientation by between −5 and 30° to the front, relative to the tool spindle.

It is preferable that the annular gap has an axial orientation or an orientation which deviates from the axial orientation by a maximum of −5 and 30°, relative to the tool spindle.

It is preferable that an annular gap located downstream of the positive pressure chamber has a gap size of between 0.03 mm and 0.5 mm.

It is preferable that the tool spindle comprises a spindle housing wherein the positive pressure chamber ends at the upper end of the spindle housing at the annular gap, and wherein both the tool or the tool spindle and the spindle casing, also at the upper end, are made from a solid and undeformable material, preferably from a metal or from a hard plastic material.

It is preferable that the gap width is constant within a tolerance of 5 percent of the gap width, in all operating modes and operation states of the machine tool.

It is preferable that the annular gap located downstream of the positive pressure chamber has an orientation coaxial to the tool axis or an orientation which deviates from the axis of the tool spindle (12) by +/−30°.

It is preferable that annular gap located downstream of the positive pressure chamber has a gap size of between 0.08 and 0.15 mm.

It is preferable that the tool has at least one annular flange which protrudes radially to the outside and the sealing air channel terminates at the annular flange.

It is preferable that the sealing air channel is configured as a bearing air channel upstream of the positive pressure chamber.

It is preferable that the bearings air passes through the bearings of the spindle and is fed with filtered air or air with an ultra high purity, to ensure the absence of particles in the bearings of the spindle.

It is preferable that at least one filter is provided upstream of the bearing air channel. It is preferable that at least one coarse filter and at least one fine filter are provided upstream of the bearing air channel.

It is preferable that the collet chuck is provided with a compressed air source which acts on the clamping jaws from behind via a pressure plate to open the clamping jaws.

It is preferable that the compressed air source feeds the sealing air channel via a pressure reduction valve.

It is preferable that the sealing air channel is fed at a positive pressure of between 0.5 bar and 4 bar and has a flow volume of between 5 liters per minute and 50 liters per minute.

It is preferable that the sealing air channel is fed at a positive pressure of between 0.5 bar and 4 bar and has a flow volume of between 10 to 20 liters per minute.

It is preferable that when the collet chuck is open, the compressed air source may output an air impulse of more than 6 bar along the collet chuck and the tool for cleaning chips from the collet chuck.

It is preferable that a plurality of nozzles is arranged distributed around the tool (14) at the tool spindle, said nozzles being directed at least partially to a machining area between the tool and the workpiece and being provided in a nozzle plate which extends in the shape of a circular ring.

It is preferable that the nozzle plate is arranged radially on the outside of the annular gap and surrounds the annular gap.

It is preferable that the nozzle plate is arranged with a deviation of less than 5 mm at the same axial height as the annular gap.

It is preferable that wherein the nozzle plate is arranged with a deviation of less than 2 mm at the same axial height as the annular gap.

It is preferable that the machine tool is a lathe grinding machine.

### BRIEF DESCRIPTION

Further advantages, details and features may be taken from the following description of several exemplary embodiments of the invention in conjunction with the drawings, in which:

FIG. 1 shows part of a machine tool, according to prior art, illustrating part of the tool spindle and the tool in a perspective illustration;

FIG. 2 shows a section through the corresponding part of an inventive machine tool, illustrating the upper part of the tool spindle, including the tool;

FIG. 3 shows a further view according to FIG. 2;

FIG. 4 shows a schematic sketch of a modified embodiment of the inventive machine tool, illustrating a differently arranged annular gap; and

FIG. 5 shows a section through the corresponding part of an inventive machine tool, illustrating the upper part of the tool spindle, including the tool.

### DETAILED DESCRIPTION

In FIG. 1, a machine tool 10 according to prior art is illustrated in parts. The machine tool 10 comprises a tool spindle 12 which carries a tool 14 and holds it clamped.

The tool spindle 12 comprises a spindle housing 16 which is configured truncated cone-shaped and ends at a nozzle plate 18. The nozzle plate 18 comprises a plurality of nozzles 20 which are intended to clean a machining area 22.

In the machining area 22, the tool 14 is in contact with a workpiece which is not illustrated such that chips or milling dust is produced thereat which is to be removed by the nozzles 20.

The chips or the milling dust is deposited no later than when the compressed air from the nozzles 20 is turned off.

The tool 14 comprises a shaft 24 which is held clamped in a collet 26 which is not illustrated in FIG. 1, see FIGS. 2, 3 and 4.

In the exemplary embodiment illustrated, the tool 14 comprises three annular flanges 28, 30 and 32 between which annular grooves 34 and 36 extend. The annular grooves 34 and 36 serve to receive the tool 14 in a gripping fork of a robot arm which is not illustrated and thus serve the tool change.

In this solution according to prior art, as is illustrated in FIG. 1, deposits are to be whirled up during operation of the machine tool 10 by housing-sided air nozzles which are additionally provided. They are removed at least partially by a suction system at the bottom.

However, when the machine tool 10 is turned off, the supply to the air nozzles, among others, the nozzles 20, is also turned off and thus the resulting milling dust and the associated chips may be deposited.

Deposits occur, among others, also on and next to the nozzle plate 18. Up to now, it was impossible to prevent deposits from entering the interior of the tool spindle 12.

As the machine tool 10 works with a lathe grinding machine of more than 30,000 rev/min, it is not possible to realize a sealing ring as it would immediately wear out at speeds of rotation of more than 5,000 rev/min.

Now, the following is provided according to the invention:

The housing 16 of the spindle is extended further to the top and ends at an annular gap 40. The annular gap 40 is the outlet of a sealing air channel 42 and extends downstream and in particular at the same time above a positive pressure chamber 44.

The positive pressure chamber 44 itself is arranged at least partially above clamping jaws 46 of the collet 26.

Thus, sealing air may escape through the sealing air channel 42 in such a way that no deposits may enter the region of the clamping jaws 46.

The flow area of the annular gap 40 is considerably smaller than that of the positive pressure chamber 44 and also slightly smaller than the flow area of the bearing air channel 50 at which position the sealing air channel 42 receives the rolling bearings (not illustrated) for mounting the spindle 12 at the housing 16.

The inventive solution is illustrated in FIG. 2.

It is also apparent from FIG. 2 that a spindle motor 54 belongs to the spindle 12. It drives the collet 26 and thus the tool 14 and is suitable for the high number of revolutions.

Additionally, the spindle motor 54 is connected non-rotatably with a flywheel 52 which also serves to compensate for imbalances and may be adapted correspondingly.

A sealing 60 is provided laterally with respect to the spindle motor 54 towards the housing 16 of the spindle 12.

The sealing air channel 42 is supplied with compressed air from a compressed air source, in the magnitude of 2 bar, wherein the compressed air source and the supply are not illustrated in detail per se.

In the exemplary embodiment illustrated, the housing 16 of the spindle is additionally configured as two pieces. The housing 16 comprises a main housing 62 and a housing insert 64 which is inserted in the main housing 62 in the front region of the cone-shaped housing 16. Here, too, sealings 66 and 68 are provided.

Further, a nozzle line 70 is apparent from FIG. 2 which terminates in the nozzle 72. The nozzle 72 corresponds to the nozzle 20 according to FIG. 1 but is positioned on a considerably higher plane such that the nozzle channel 70 is also extended.

FIG. 3 shows an amended embodiment, compared to FIG. 2, in another view and enlarged. Here, the same reference signs indicate the same parts as in the further figures and the embodiment is slightly changed.

It is apparent that the tool 14 is held in a tool holder 76 in the collet 26. Especially this region in which the tool 14 is held radially in a clamped manner is protected inventively by the sealing air such that reliable and centered clamping of the tool 14 at its shaft 24 is possibly free of contamination.

A further modified configuration of the inventive machine tool 10 is apparent from FIG. 4. In this solution, the annular gap 40 is oriented radially. Even if the machine is at a standstill, a deposit which is deposited vertically may not enter the annular gap 40. Again, the annular gap 40 is between the annular flange 30 and the housing 16 of the tool spindle 12.

A nozzle plate 18 is configured radially on the outside of the annular gap 40 wherein a nozzle 72 with a nozzle channel 70 is illustrated.

It is also apparent from FIG. 4 that the positive pressure chamber 44 extends considerably above the collet 26. The collet 26 comprises clamping jaws 46 of which one clamping jaw 46 is illustrated in FIG. 4 in turn.

The sealing air channel 42 comprises also the bearing air channel 50 besides the positive pressure chamber 44. At this axial position rolling bearings are provided of which two rolling bearings 80 and 82 are apparent from FIG. 4. Bearings air streams through both rolling bearings 80 and 82 in a way known per se, said bearing air itself streaming through the positive pressure chamber 44 as sealing air and escaping at the annular gap 40.

It is also apparent from FIG. 4 that the clamping jaws 46 have a slightly conical external surface each. They interact with a corresponding surface at the collet 26.

FIG. 4 further shows an air flow path of the bearing air indicated by arrows through the bearing air channel 50 and thus through the rolling bearings 80 and 82.

Upstream of the rolling bearings 80 and 82, preferably at the inlet of the bearing air channel 50, at least one filter 77 (shown in FIG. 5), preferably first at least one coarse filter upstream of at least one fine filter, is connected to ensure the purity of the bearings air. If more filters are used they are connected in series, while the air is filtered by ever finer filters to maximize air purity.

This is essential because even slight impurities in the bearing air, like fine dust grains, could lead to substantial damage in the bearings or even destruction of the bearings at high rotational speeds like the ones used in the invention, especially at rotational speeds of more than 30,000 rpm, and even up to 60,000 rpm.

By means of a tension spring 84 the clamping jaw 46 is drawn to the rear in the axial direction such that it holds the tool 14 clamped at its shaft 24.

When the clamping jaw 46 is pushed to the front, i.e., in the illustration according to FIG. 4 to the top, by means of a pressure plate 86, the tool 14 is released and can be exchanged.

The clamping jaw 46 may be lifted by the pressure plate 86 activated by compressed air such that the sealing function thereat is cancelled and compressed air streams along the tool 14 and also enters the positive pressure chamber 44. This ensures that no deposits may enter the region of the tool holder.

1. A machine tool comprising
a tool spindle having a collet chuck and a spindle motor,
an air channel which runs radially outside of the collet chuck,
wherein the collet chuck has at least two clamping jaws which are configured for receiving and releasing a tool, and
wherein the air channel is configured as a sealing air channel (42) and forms a positive pressure chamber (44) at least partially above the clamping jaws (46).

2. The machine tool as claimed in claim 1,
wherein the positive pressure chamber (44) terminates in an annular gap (40) or wherein the annular gap (40) is arranged downstream of the positive pressure chamber having one gap side formed by the tool (14) or the tool spindle (12).

3. The machine tool as claimed in claim 1,
wherein an annular gap (40) located downstream of the positive pressure chamber (44) has a gap size of between 0.03 mm and 0.5 mm.

4. The machine tool as claimed in claim 1,
wherein an annular gap (40) located downstream of the positive pressure chamber (44) has an orientation coaxial to the tool axis or an orientation which deviates from the axis of the tool spindle (12) by +/−30°.

5. The machine tool as claimed in claim 1,
wherein the tool (14) has at least one annular flange (28, 30, 32) which protrudes radially to the outside, and
wherein the sealing air channel (42) terminates at the annular flange (30).

6. The machine tool as claimed in claim 1,
wherein the sealing air channel (42) is configured as a bearings air channel (50) upstream of the positive pressure chamber (44).

7. The machine tool as claimed in claim 1,
wherein the collet chuck is provided with compressed air which acts on the clamping jaws (26) from behind via a pressure plate (86) to open the clamping jaws (26).

8. The machine tool as claimed in claim 7,
wherein the compressed air feeds the sealing air channel (42) via a pressure reduction valve (42).

9. The machine tool as claimed in claim 7,
wherein the sealing air channel (42) is fed at a positive pressure of between 0.5 bar and 4 bar and has a flow volume of between 5 liters per minute and 50 liters per minute.

10. The machine tool as claimed in claim 1,
wherein, when the collet chuck is open, the compressed air source may output an air impulse of more than 6 bar along the collet chuck and the tool (14) for cleaning chips from the collet chuck.

11. The machine tool as claimed in claim 2,
wherein the annular gap (40) which is covered and/or limited by an annular flange (28, 30, 32) has a radial orientation or an orientation which deviates from the radial orientation by between −5 and 30° to the front, relative to the tool spindle (12).

12. The machine tool as claimed in claim 2,
wherein the annular gap (40) has an axial orientation or an orientation which deviates from the axial orientation by a maximum of −5 and 30°, relative to the tool spindle (12).

13. The machine tool as claimed in claim 1,
wherein a plurality of nozzles is arranged distributed around the tool (14) at the tool spindle (12), said nozzles being directed at least partially to a machining area (22) between the tool (14) and the workpiece and being provided in a nozzle plate which extends in a shape of a circular ring.

14. The machine tool as claimed in claim 13,
wherein the nozzle plate is arranged radially on the outside of the annular gap (40) and surrounds the annular gap (40).

15. The machine tool as claimed in claim 14,
wherein the nozzle plate is arranged with a deviation of less than 5 mm at the same axial height as the annular gap (40).

16. The machine tool as claimed in claim 1,
wherein the machine tool is a lathe grinding machine.

17. The machine tool as claimed in claim 1,
wherein an annular gap (40) located downstream of the positive pressure chamber (44) has a gap size of between 0.08 and 0.15 mm.

18. The machine tool as claimed in claim 7,
wherein the sealing air channel (42) is fed at a positive pressure of between 0.5 bar and 4 bar and has a flow volume of between 10 to 20 liters per minute.

19. The machine tool as claimed in claim 14,
wherein the nozzle plate is arranged with a deviation of less than 2 mm at the same axial height as the annular gap (40).

20. The machine tool as claimed in claim 3,
wherein the tool spindle comprises a spindle housing (16),
wherein the positive pressure chamber (44) ends at the upper end of the spindle housing (16), at the annular gap (40), and
wherein both the tool (14) or the tool spindle (12) and the spindle casing (16), also at the upper end, are made from a solid and undeformable material.

21. The machine tool as claimed in claim 3,
wherein the gap width is constant within a tolerance of 5 percent of the gap width, in all operating modes and operation states of the machine tool.

22. The machine tool as claimed in claim 6,
wherein the bearings air passes through the bearings (80, 82) of the spindle (12) and is fed with filtered air or air with an ultra high purity, to ensure the absence of particles in the bearings (80, 82) of the spindle (12).

23. The machine tool as claimed in claim 6,
wherein at least one filter is provided upstream of the bearings air channel (50).
